(19) United States
(12) Patent Application Publication
(10) Pub. No.: US 2014/0337112 A1
(43) Pub. Date: Nov. 13, 2014

(54) SYSTEM AND METHOD FOR CREATING AND SHARING PRODUCT ENSEMBLES WITH AN ELECTRONIC PIN BOARD WALL

(71) Applicant: QUALCOMM Incorporated, San Diego, CA (US)

(72) Inventor: Robert DESSERT, San Diego, CA (US)

(73) Assignee: QUALCOMM Incorporated, San Diego, CA (US)

(21) Appl. No.: 13/890,432

(22) Filed: May 9, 2013

(51) Int. Cl. G06Q 30/02

(52) U.S. Cl. CPC G06Q 30/0267; G06Q 30/0222
USPC 705/14.23; 705/14.64

(57) ABSTRACT

A method and system for creating and sharing product ensembles between a portable computing device (“PCD”) and a pin board wall includes receiving product scan data for a product and displaying a visual representation of the product on a display of a PCD as part of a product ensemble. A product ensemble includes two or more products grouped together. Next, a command to transfer the product ensemble from a PCD to a pin board wall may be received. A pin board wall may comprise a display that is generally larger than the display of the PCD. Data for the product ensemble may then be transferred over a communications network from the PCD to the pin board wall. The transferred product ensemble is then displayed on the pin board wall. A command may also be received to transfer the product ensemble from the pin board wall to another PCD.

### DESCRIPTION OF THE RELATED ART

Product manufacturers, merchants, and service vendors spend billions of dollars every year to advertise their products and services to the public. One major problem with advertising is it is difficult to catch or draw the attention of an individual consumer as well as groups of consumers who may span a broad range of demographics.

Billboards, magazine advertisements, newspaper advertisements, online interactive advertisements and the like typically project images of human models that are usually pleasing to the eye. Often, human models are dressed and styled to look like an average or ordinary consumer.

These conventional forms of advertising products often do not provide significant returns for the store merchants who pay for them. What is needed are new and cost effective techniques for attracting the attention of a wider range of individuals to products that may span across multiple demographics.

### SUMMARY OF THE DISCLOSURE

A method and system for creating and sharing product ensembles between a portable computing device (“PCD”), such as a private device like a mobile phone, and a public/social device, such as an electronic pin board wall, includes receiving product scan data for a product and displaying a visual representation of the product on a display of a PCD as part of a product ensemble. A product ensemble includes two or more products grouped together. Next, a command to transfer the product ensemble from a PCD to the electronic pin board wall may be received. An electronic pin board wall may comprise an electronic display that is generally larger than the display of the PCD. Data for the product ensemble may then be transferred over a communications network from the PCD to the pin board wall. The transferred product ensemble is then displayed on the pin board wall. A command may also be received to transfer the product ensemble from the pin board wall to another PCD.

A pointer on the pin board wall may be displayed in a location generally corresponding to an angle of the PCD relative to the pin board wall. A command may also be received from a PCD to change one or more elements of the transferred product ensemble. A persona may be determined by the PCD and/or a controller for associating with the product scan data. A persona includes a profile of one or more people designated by a primary account holder, such as a spouse and one or more children.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral encompass all parts having the same reference numeral in all Figures.

FIG. 1A is a diagram of a system for creating and sharing product ensembles;

FIG. 1B is a diagram illustrating more elements of the system for creating and sharing product ensembles illustrated in FIG. 1A;

FIG. 2A is a diagram of an exemplary embodiment of the system for creating and sharing product ensembles in which a first product ensemble has been created and transferred from a first portable computing device to a pin board wall and then downloaded by a second portable computing device in communication with the pin board wall;

FIG. 2B is a continuation diagram for FIG. 2A in which a third product ensemble has been created by the second portable computing device and then transferred from the second portable computing device to the pin board wall;

FIG. 3 is a diagram of system for determining the direction of transfer of product ensembles to and from a portable computing device relative to a pin board wall;

FIG. 4A is a functional block diagram for a portable computing device, such as a mobile phone;

FIG. 4B is a diagram of exemplary software modules which may be part of a client application module that is part of the system for creating and sharing product ensembles;

FIG. 4C is an exemplary screen display for a portable computing device which allows an operator to provide comments about a product;

FIG. 4D is a diagram of an exemplary screen display for adjusting settings of a persona manager 427 that may be part of the client application module running on the PCD;

FIG. 5 is a diagram of a general purpose computer which may be part of the controller for the pin board wall;

FIG. 6A is a flowchart illustrating a method for creating and sharing ensembles;

FIG. 6B is a continuation flowchart of FIG. 6A illustrating the method for creating and sharing ensembles; and

FIG. 7 is an exemplary screen display for a pin board wall that supports communications in connection with a televised live event.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device (“PCD”) may include a cellular telephone, a pager, a personal digital assistant (“PDA”), a smartphone, a navigation device, or a hand-held computer with a wireless connection or link.

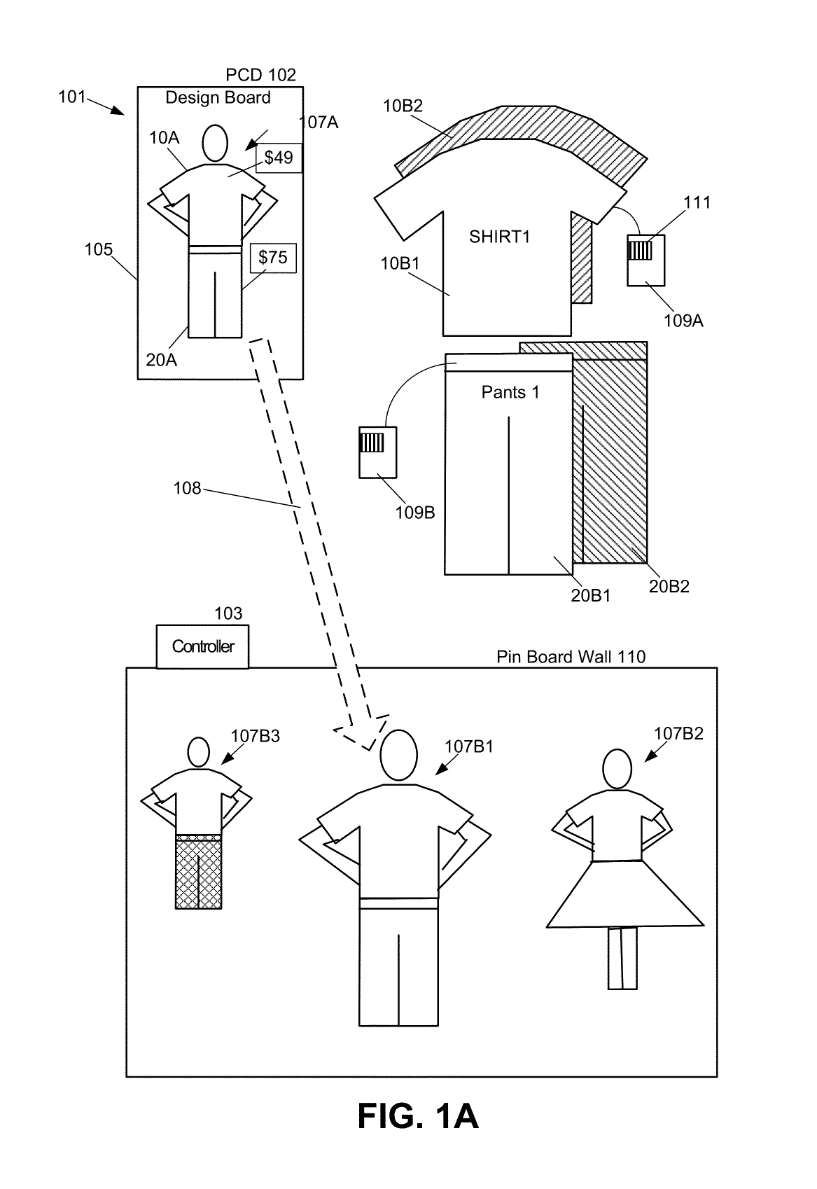

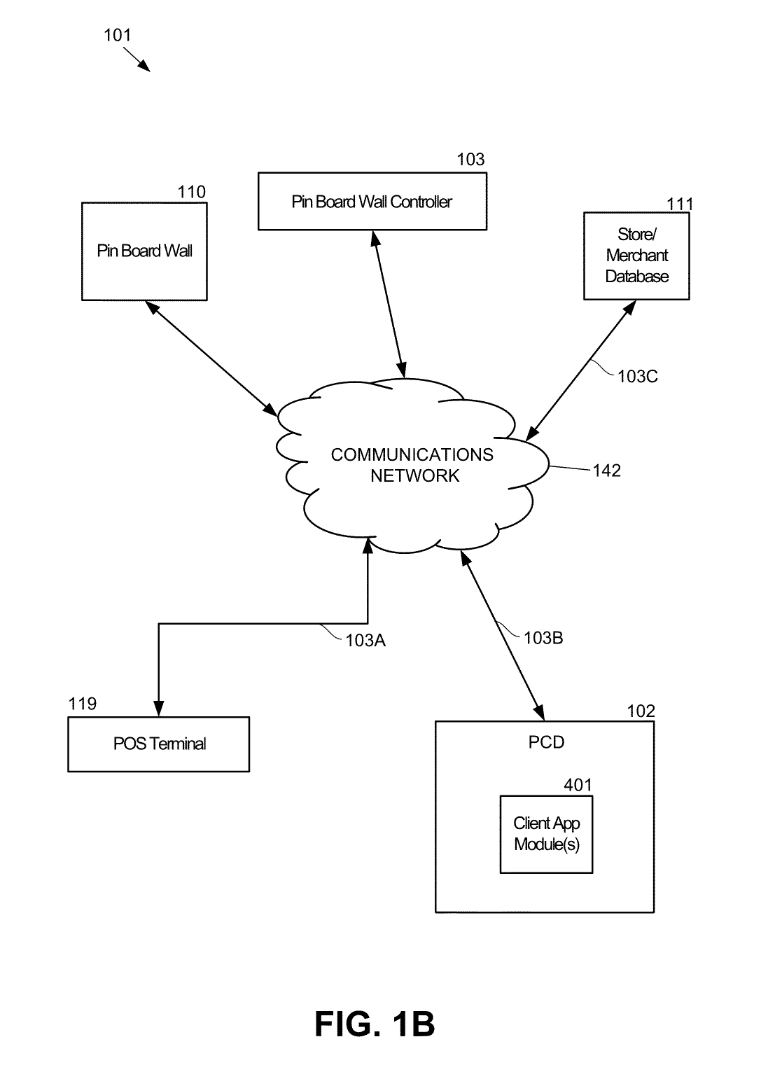

Referring initially to FIG. 1A, this figure is a diagram of a system 101 for creating and sharing product ensembles 107 according to one exemplary embodiment. The system 101 may comprise a portable computing device (“PCD”) 102 which has a screen display 105. A product ensemble 107 typically comprises one or more products 10, 20 and/or symbols representing services that may be selected by an operator of the PCD 102 and/or which may be selected automatically by the PCD 102 as will be described in further detail below. In a single product ensemble, a single product 10, 20 may be displayed adjacent to text which may describe the product.

Products 10, 20 may comprise any type of product sold to a consumer. In the exemplary embodiment illustrated in FIG. 1, the products 10, 20 may comprise clothing such as shirts 10, and pants 20. However, the inventive system 101 may address any type of product and/or service. Other exemplary products types include, but are not limited to, animals and pet supplies; other apparel and accessories; arts and entertainment; baby and toddler goods; business and industrial goods; cameras and optics goods; electronics; food, beverages and tobacco; furniture; hardware; health and beauty goods; home and garden goods; luggage and bags; media; office supplies; religious and ceremonial goods; software; sporting goods; toys and games; vehicles and parts; and other similar product types.

For services, the inventive system 101 may display symbols as well as other graphical elements, such as photographs, which may relate to or illustrate one or more services. Services may include any type such as professional services like legal services, accounting services, and travel services, and the like. Other services may include other ordinary consumer services like car washes, dry cleaning, home repairs, etc.

The screen display 105 illustrated in FIG. 1 is part of a portable computing device 102 and it comprises a design board with a first product ensemble 107A which was created by the operator of the PCD 102 by scanning in product tags 109A,109B. Alternatively, the operator of the PCD 102 may create a product ensemble 107A by taking a digital photograph of the product 10, 20 desired to be displayed on the design board. The operator of the PCD 102 may also perform an electronic databases product search with the PCD 102 to select products 10, 20 uncovered from that search. Other ways of selecting products 10, 20 for incorporation into the design board display 105 are understood by one of ordinary skill in the art and are included within the scope of this disclosure.

In the exemplary embodiment illustrated in FIG. 1A, the operator of the PCD 102 scans the product tags 109 to “retrieve” the products 10, 20 into the design board display 105 of the PCD 102. Product tags 109B may comprise machine-readable codes 111 that may be processed by the PCD 102 as well as human readable alphanumeric characters which provide pricing information as well as product information.

The machine-readable codes 111 may comprise two-dimensional (“2-D”) barcodes. The 2-D barcodes may include, but are not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, for example.

Instead of a two dimensional bar code, a one dimensional bar code may be employed. Exemplary one-dimensional bar codes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, and Telepen.

Other machine readable codes 111 are well within the scope of the disclosure such as contact-less or wireless communication methods such as near-field communications (“NFCs”) used with smart cards and radio-frequency identification (“RF-ID”) cards as understood by one of ordinary skill in the art.

When the operator of the PCD 102 scans in the machine-readable code 111 from the product tag 109, a PCD 102 may pre-populate the screen display 105 comprising a design board with a visual representation of the product 10, 20 which was just scanned with the PCD 102. In the clothing context, the PCD 102 may also project the visual representation of the product 10, 20 on a human form or mannequin to enhance the shopping experience for the operator of the PCD 102. In addition to displaying each product 10, 20, the PCD 102 may also display pricing information adjacent to each product 10, 20.

In the exemplary embodiment illustrated in FIG. 1, the operator of the PCD 102 may scan in the product tag 109A for the shirt product 10B1 with the PCD 102 and the PCD 102 may then generate a visual representation of the scanned shirt product 10A on the design board of the exemplary screen display 105 of the PCD 102. The visual representation of the scanned shirt product 10A will usually have physical features corresponding to the real or physical shirt product 10B1, such as having the same color and/or pattern. In other exemplary embodiments, the PCD 102 may adjust the displayed product 10, 20 according to preferences of the persona associated with the scanned product 10, 20. For example, if the persona associated with the scanned product 10, 20 had a preference for the color of blue for a shirt product 10, then if the actual physical shirt 10B1 was red in color, then the PCD 102 may adjust the visual representation of the scanned shirt product 10A from the red color to the blue color which is listed as a preference according to the persona.

Similarly, the operator of the PCD 102 may scan in the product tag 109B for the pants product 20B with the PCD 102 and the PCD 102 may then generate a visual representation of a pants product 20 on the design board of the exemplary screen display 105 of the PCD 102. The visual representation of the scanned pants product 20A will usually have physical features corresponding to the real or physical pants product 20B, such as having the same color and pattern.

In some exemplary embodiments, after scanning of a physical product 10, 20 or a tag 109, the digital representation of the product(s) may placed on the design board 105, but not necessarily placed on the digital mannequin or associated to an ensemble 107. The products 10, 20 may be displayed adjacent to each other but not placed on the digital mannequin until instructed by the operator of the PCD 102. This exemplary feature is analogous to a situation in which clothing products 10, 20 are brought into a dressing room. The clothing products 10, 20 may be in a pile on the floor until the customer tries each piece of clothing on. The clothing products 10, 20 liked by the operator get associated by the PCD 102 to an ensemble 107 and displayed on the digital mannequin within the display 105; the ones not liked by the operator may “be left on the floor” in the dressing room and not placed on the mannequin.

Alternatively, when the operator of the PCD 102 scans in the product tag 109A for the shirt product 10B1 with the PCD 102, the PCD 102 may then generate a visual representation of the scanned shirt product 10A on the design board of the exemplary screen display 105 of the PCD 102. Next, the PCD 102 may automatically suggest the pants product 20A and automatically populate the screen display 105 with the pants product 20A positioned adjacent to the visual representation of the scanned shirt product 10A. In this way, the PCD 102 has helped the operator create the product ensemble 107A as illustrated on the design board of the screen display 105 of FIG. 1.

As one example, recommendations by the PCD 102 could be drawn from prior interests of the operator of the PCD 102 such as, but not limited to, prior purchases, other shopper's combined purchases (people who bought this, also bought this), or social trends. The PCD 102 and/or controller 103 may conduct searches of unstructured data such as SMS, TWITTER™ brand short social media message posts, FACEBOOK™ brand social media posts, PINTEREST™ brand social postings pins/re-pins, and other short messaging systems, such as INSTAGRAM™ brand postings, etc. These sources may be searched and attributed with varying degrees of influence. These sources may be compared against the inventory of the controller 103 to determine a set of recommendations that are currently available. The PCD 102 and controller 103 may be programmed so that products 10, 20 that are not available will not be displayed on the PCD 102, and ideally only those products 10, 20 that are currently available (or omni-channel available for same-day/next-day delivery) in the associated persona's size may be displayed.

The operator may replace a product suggestion made by the PCD 102 by scanning in a similar class or category of product relative to the suggested product. For example, in the clothing example illustrated, the PCD 102 may suggest a first pair of pants 20A and the operator may then scan in a second pair of pants 20B2 which were different relative to the first pair of pants 20A but would be replaced with a visual representation representing the second pair of pants 20B which were scanned by the operator with the PCD 102.

The PCD 102 may have ensemble templates. For instance, a Men's Casual Outfit template may permit 0-3 shirts 10 (layering) for display but the PCD 102 may restrict display to one required pair of pants 20, etc.

According to one exemplary embodiment of the system 101, as indicated by the dashed arrow 108, the operator of the PCD 102 having display 105 may “swipe” or transfer the product ensemble 107A to a larger display/pin board wall 110 by aiming the display 105 of PCD 102 towards the geometric planer surface defined by the pin board wall 110.

It is noted that while the pin board wall 110 is typically larger than the PCD 102, one interesting aspect of the pin board wall 110 relative to the PCD 102 is that it is public or social whereas the PCD 102 is typically private. This means that the pin board wall 110 may comprise elements other than just a large video display. For example, the pin board wall 110 may comprise a semi-private web display that is only accessible in store on a shopper's PCD 102, or in another embodiment, the ensembles 107 destined for a wall 110 may become a projection onto a three-dimensional form in the store as an augmented mannequin display. The pin board wall 110 is not limited to these publicly accessible elements and may comprise others as understood by one of ordinary skill in the art.

The product ensemble 107B1 which is transferred to the pin board wall 110 as illustrated in FIG. 1A is identical to the product ensemble 107A that is present on the display 105 of the PCD 102. The only difference between the product ensemble 107B1 and the product ensemble 107A is that the product ensemble 107B1 may have a size which is significantly larger than the size of the product ensemble 107A residing on the PCD 102.

In other exemplary embodiments, an ensemble template managed by the PCD 102 may designate the display of the ensemble 107 on the PCD 102 applied to a mannequin. Meanwhile, on the pin board wall 110, the controller may display the ensemble 107 as an overlapping stack of clothes 10, 20 laid out in a mood board manner. Another example may be a home theater display on the limited form factor of a PCD 102 may be diagrammatic from a top view of a room, whereas the larger space on a pin board wall 110 may allow an animated three-dimensional view of the room rotating with a simulated movie playing on the screen. These graphical features of the pin board wall 110 may give greater incentive for a shopper to post to a pin board wall 110.

As illustrated in FIG. 1A, the pin board wall 110 may comprise a multi-panel display array. Exemplary dimensions for the pin board wall 110 include, but are not limited to, a four feet wide by three feet high array of 40 inch flat panel monitors associated to a common video controller. However, other sizes larger and smaller are included within the scope of this disclosure as understood by one of ordinary skill in the art. The pin board wall 110 may comprise a touch display technology so that users may interact with it using touch. The pin board wall 110 should be capable of supporting interactions from a plurality of users simultaneously.

For example, multi-user interaction may include, but is not limited to, simultaneous events that can occur—from posting from multiple PCDs 102 to a single pin board wall 110, retrieving of multiple ensembles 107 on a single pin board wall 110 to multiple PCDs 102, multiple users tapping multiple ensembles 107 on the pin board wall 110 for additional information while other operators of PCDs 102 are posting and/or retrieving with their respective PCDs 102.

The product ensemble 107B1 displayed on the pin board wall 110 may have a height of 36 inches while the product ensemble 107A residing on the PCD 102 may have a height of 3 inches, as understood by one or a skill the art. In addition to PCDs 102 transferring product ensembles 107 to the pin board wall 110, PCDs 102 may also “pull-down” product ensembles 107B 1 from the pin board wall 110 into a respective PCD 102.

In other words, if an operator of a PCD 102 sees a product ensemble 107B1 that is of interest to the operator of the PCD 102, then the operator of the PCD 102 may “aim” a display 105 of the PCD 102 towards geometric planer surface defining the pin board wall 110 and then “swipe-down” the product ensemble 107B1 into the PCD 102. Alternatively, the operator PCD 102, they physically touch the pin board wall 110 and perform a “swipe gesture” or some other gesture, such as tapping twice on the pin board wall 110, so that the product ensemble 107B1 of interest is downloaded into the PCD 102.

Other gestures are included within the scope of the system 101. The system 101 may include all natural user interface gesturing that identifies the ensemble 107 of interest and conveys the desire to have it copied to the PCD 102 and/or from the PCD 102 to the pin board wall 110. For example, another gesture includes capturing a “pinching gesture” as if picking up the ensemble 107 and a release gesture (going from index finger and thumb touching to open palm) over the PCD screen 105.

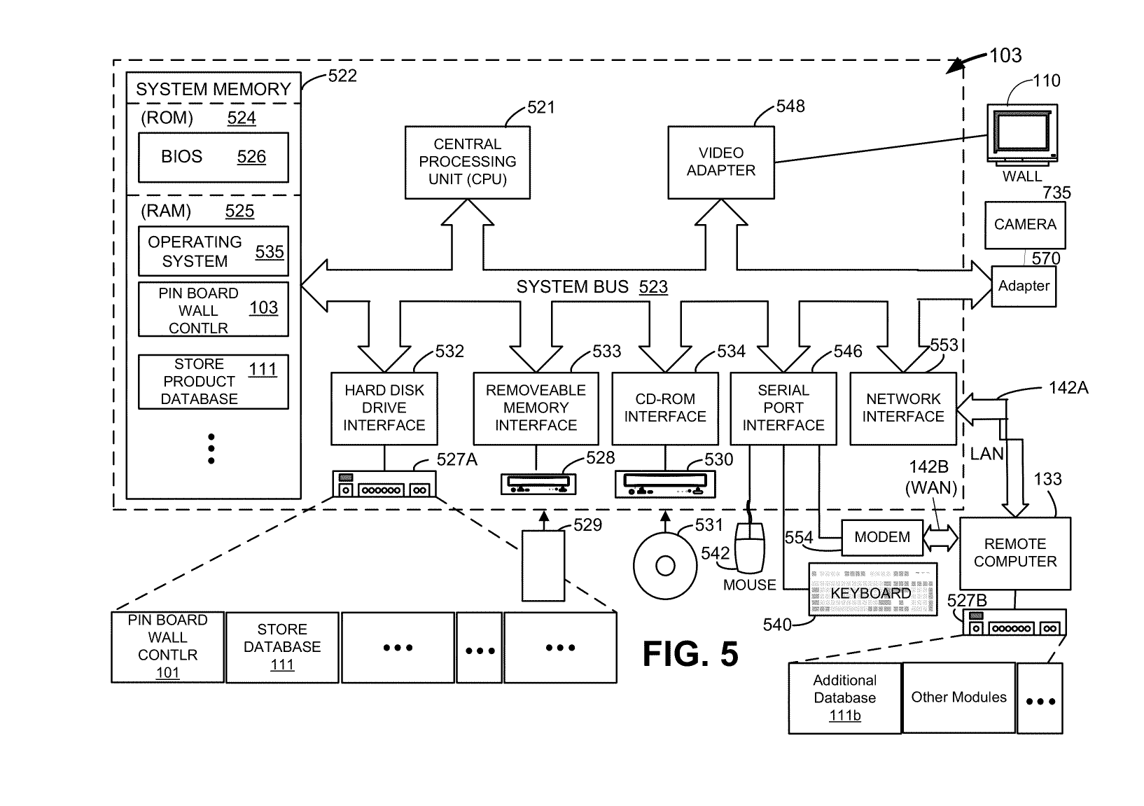

The pin board wall 110 may operate under commands issued from a controller 103. The controller 103 may comprise a general purpose computer as will be described in further detail below in connection with FIG. 5. The controller 103 may receive one or more product ensembles 107 from a plurality of PCDs 102. The controller 103 may track the product ensembles 107 which are the most popular among the PCDs 102 that are present within a particular store.

In other words, the controller 103 may track popularity of product ensembles 107 by determining how many PCDs 102 have downloaded a particular product ensemble 107 which was posted on the pin board wall 110. Other ways of determining popularity of product ensembles 107 are included within the scope of this disclosure.

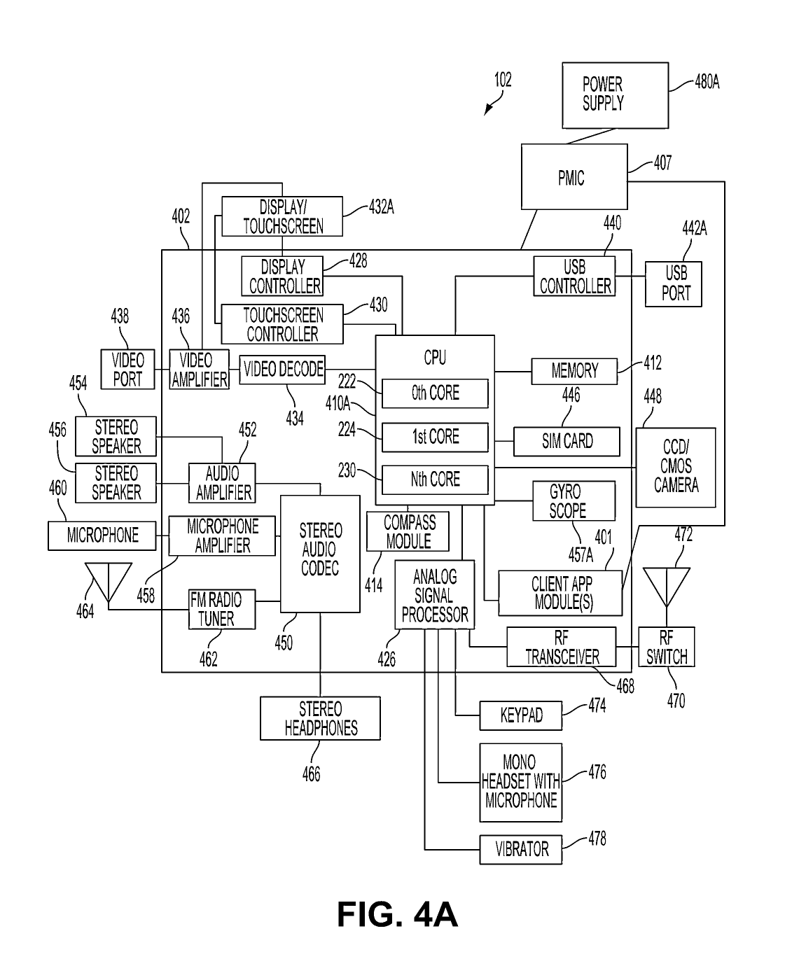

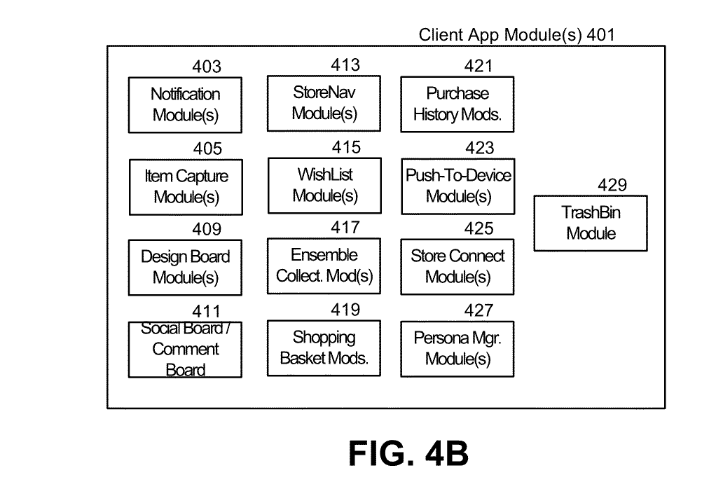

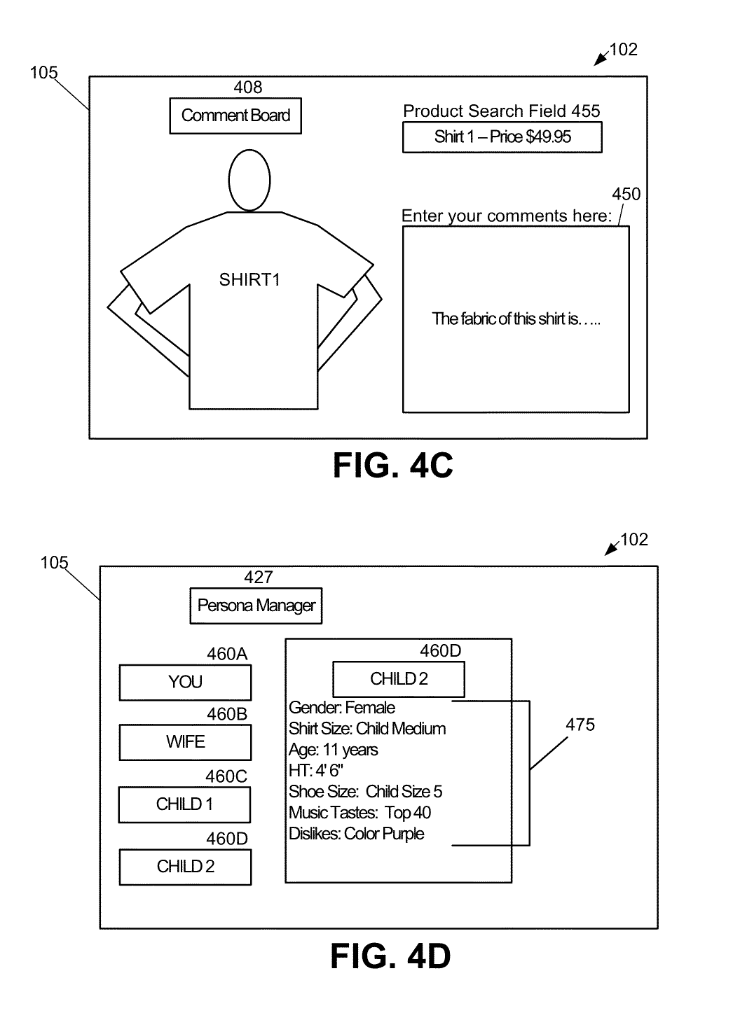

For example, another way to track popularity of a product ensemble 107 is to tally or keep track of positive comments posted about the product ensemble 107 on the pin board wall 110 and/or posted by PCDs 102 by text messages and/or comments written about the product ensemble using a comment board 411 which will be described in further detail in connection with FIG. 4C below. Another example would be the controller 103 counting taps on the ensemble 107 to retrieve more details and/or pricing about the individual products 10,20 and/or services that comprise the ensemble 107.

The controller 103 for the pin board wall 110 may track trending among the various product ensembles 107 which are posted to the pin board wall 110. In other words, the controller 103 may determine which product ensembles 107 are more popular relative to each other.

To visually identify which product ensembles 107 or more popular, the controller 103 may adjust one or more different visual properties of each product ensemble 107. For example, the controller 103 may adjust the size of product ensembles in order to visually identify which product ensembles 107 are more popular than those which are less popular. For those product ensembles 107 which are popular, the controller 103 may make these product ensembles 107 much larger in size relative to those product ensembles 107 which are less popular.

Alternatively, or in addition to sizing, the controller 103 may also make popular product ensembles 107 more bright by increasing their light intensity while making less popular product ensembles 107 less bright with decreasing their luminosity or increasing their transparency and eventually fading away as their popularity diminishes. In the exemplary embodiment illustrated in FIG. 1A, the first product ensemble 107B1 may have a height which is significantly larger than the height of a second product ensemble 107B2. This indicates that the first product ensemble 107B1 is currently more popular than the second product ensemble 107B2. Similarly, the second product ensemble 107B2 may have a height/size which is greater than a third product ensemble 107B3 to indicate that the second product ensemble 107B2 has a current popularity which is greater than the popularity of the third product ensemble 107B3.

In addition to sizing and relative brightness, the controller 103 may also adjust the positioning of product ensembles 107 within the pin board wall 110. Those product ensembles 107 having a higher popularity may be positioned within a central region of the pin board wall 110 while those product ensembles 107 having lesser popularity may be positioned within the outer regions defined by the pin board wall 110. Each of the ensembles may also appear to “float” or slowly move in order to attract attention from store patrons. Other visual techniques for the ensembles 107 are within the scope of the disclosure as understood by one of ordinary skill the art.

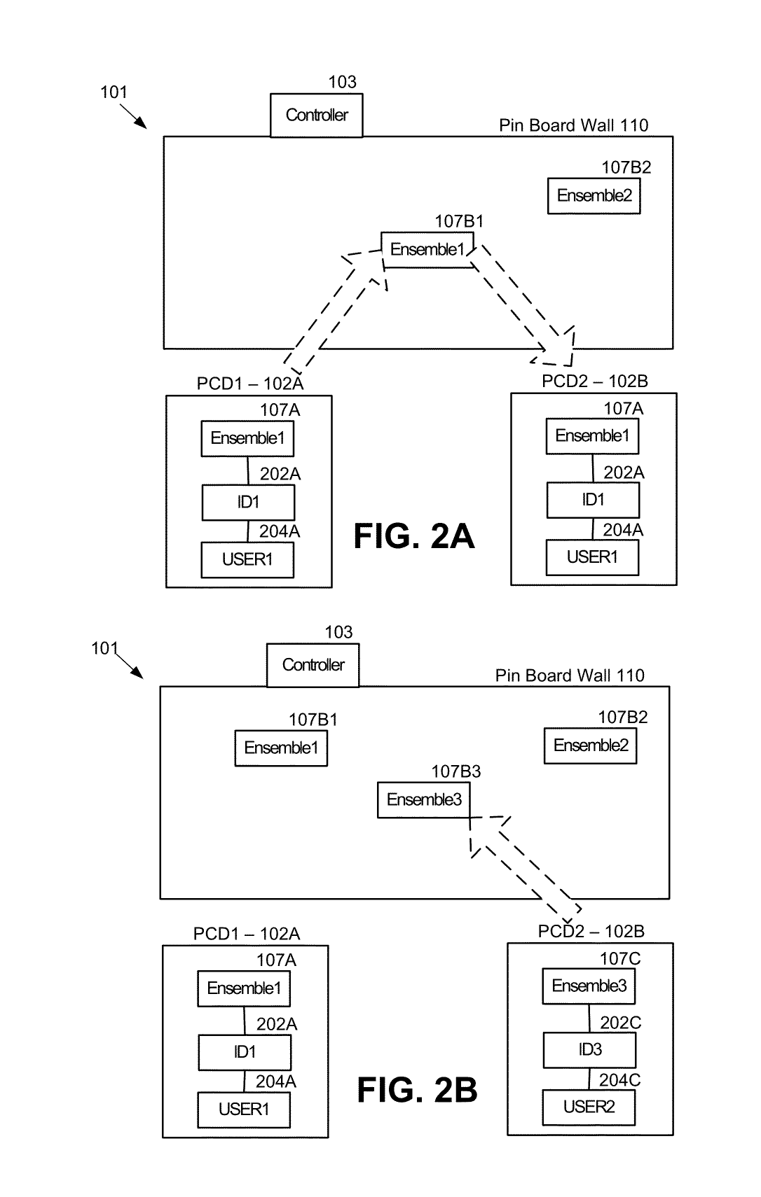

The controller 103 may track the creators/originators of product ensembles 107 which are posted to the pin board wall 110. The tracking system employed by the controller 103 may be fairly robust as appropriate so that the controller 103 may award incentives/attribution for operators of PCDs 102 who produce product ensembles 107 and to post them on the pin board wall 110. For example, one incentive for producing a product ensemble 107 and then posting it on the pin board wall 110 may include a discount on purchase price of the product ensemble 107 if a suggested product ensemble 107 is purchased by a predetermined number of customers beyond the originator of the product ensemble 107 or if the ensemble 107 trends “popular” for a predetermined period of time. One such tracking system that may be employed/used by the controller 103 is described below in connection with FIGS. 2A-2B.

Referring now to FIG. 1B, this figure is a diagram illustrating more elements of the system 101 for creating and sharing product ensembles 107 illustrated in FIG. 1A. The system 101 may comprise a PCD 102, a controller 103, and the pin board wall 110 as described above in connection with FIG. 1A. The system 101 may further comprise a store/product information database 111 and a point-of-sale (“POS”) terminal 119. The product information database 111 may comprise detailed information about each product 10, 20 (SEE FIG. 1A) which may be sold at a particular store. The PCD 102 may gain access to the store database 111 by a client application program module 401 which will be described in further detail below in connection with FIG. 4B. The database 111 may also include inventory management systems (that comprise local, nearby stores, and ecommerce) as well as data from online reviews and ratings from ecommerce systems.

Each of the elements of system 101 illustrated in FIG. 1B may be coupled to a communications network 142 via links 103. The communication links 103 illustrated in FIG. 1B may comprise wired or wireless communication links. Wireless communication links include, but are not limited to, radio-frequency (“RF”) links, such as BLUETOOTH™ RF links as well as infrared links, acoustic links, and other wireless mediums. The communications network 142 may comprise a wide area network (“WAN”), a local area network (“LAN”), the Internet, a Public Switched Telephony Network (“PSTN”), or any combination thereof.

The communications network 142 may be established by broadcast RF transceiver towers (not illustrated). However, one of ordinary skill in the art recognizes that other types of communication devices besides broadcast RF transceiver towers are included within the scope of the system 100 for establishing the communications network 142. The exemplary communication network 142 of FIG. 1A may employ wireless communications towers (not shown) which couple to the antennas of the portable computing device (PCD) 102.

FIG. 2A is a diagram of an exemplary embodiment of the system 101 for creating and sharing product ensembles 107 in which a first product ensemble has been created 107A and transferred from a first portable computing device 102A to a pin board wall 110 and then downloaded by a second portable computing device 102B in communication with the pin board wall 110. In this exemplary embodiment, the client application module 401 (not illustrated in this figure, but SEE FIG. 4B) running on the portable computing devices 102 working with the controller 103 20 pin board wall 110 may assign each product ensemble 107 a unique identifier 202 as well as a user identifier 204 to indicate the originator/creator of the ensemble 107. The unique identifier 202 and the user identifier 204 may comprise any number of alphanumeric text characters. Both the client application module 401 residing on the PCD 102 and the controller 103 may track this information.

So when the operator of the first PCD 102A decides to “swipe-up” the first product ensemble 107A from the display 105A first PCD 102A to the pin board wall 110, the product ensemble identifier 202A along with the user identifier 204A may be transferred to the controller 103. Upon receiving the identifiers 202A, 204A in information about the product ensemble 107A from the PCD 102A, the controller 103 may display the product ensemble 107B1 on the pin board wall 110.

When a second operator of a second PCD 102B desires to download the product ensemble 107B1 from the pin board wall 110, the operator of the second PCD 102B may “swipe-down” the product ensemble 107B1 and its related data from the pin board wall 110 to the display 105B of the second PCD 102. The data relating to the product ensemble one of 71 which was downloaded may include the first product ensemble identifier 202 A, and the first user identifier 204B.

If the second operator of the second PCD 102B decides to change any aspects of the downloaded first product ensemble 107B1, then the client application model 401 and/or the controller 103 may assign a new product ensemble identifier 202C and a new user identifier 204C as will be described below in connection with FIG. 2B. Alternatively, or in addition to assigning new product ensemble identifiers 202 and new user identifiers 204 for an “improved” product ensemble 107, the controller 103 and/or the client application module 401 may associate the original parts or products of the product ensemble 107 with the first product ensemble identifier 202A and the first user identifier 204A. Any new parts or products added to the original product ensemble 107B1 may then be assigned the new product ensemble identifier 202 and the user identifier 204 associated with the operator who is adding the new parts or products to the original product ensemble 107B1 (which forms the new product ensemble 107B3 illustrated in FIG. 2B as will be described below).

FIG. 2B is a continuation diagram for FIG. 2A in which a third product ensemble 107B3 has been created by the second portable computing device 102B and then transferred from the second portable computing device 102B to the pin board wall 110. The second portable computing device 102B is forming a new third product ensemble 107B3 because a second product ensemble 107B2 was already present or existing on the pin board wall 110 as tracked by the controller 103.

As discussed previously, according to one exemplary embodiment, if the operator of the second portable computing device 102 changes any part of the first product ensemble 107B1, then a new product ensemble identifier 202C and a user identifier 204C may be assigned by the client application 401 working with the controller 103.

As mentioned above, the controller 103 may track the creation of product ensembles 107 so that incentives may be awarded to the operators of PCDs 102 who originate the product ensembles 107. Incentives may include, but are not limited to, discounts applied to the product ensemble 107 when purchased by the creator of the product ensemble 107. The discounts applied may be adjusted based on a sliding scale of consumption/popularity of the product ensemble 107 that was created. Higher discounts may be awarded for a higher number of sales generated by the display of the product ensemble 107.

In other words, the controller 103 may track product ensembles 107 which are purchased after the creation and posting of a product ensemble on the pin board wall 110. The creator of the product ensemble 107 may be awarded a discount percentage off of the purchase of a product ensemble 107 depending upon the number of store patrons to purchase the product ensemble 107 after it is created in posted on the pin board wall 110. Other incentives are included within the scope of this disclosure and include, but are not limited to, cash awards, gift cards, loyalty points, etc. which may be awarded to product ensemble creators.

In the alternate exemplary embodiment in which product ensembles 107 may be assigned a plurality of product ensemble identifiers 202 and user identifiers 204 in order to track multiple co-creators and their respective contributions to a single product ensemble 107, the co-creators of such product ensembles 107 may be awarded a percentage discount based on their corresponding contributions to the overall ensemble 107. In other words, a co-creator that contributes a greater number of products for a product ensemble 107 be awarded a higher percentage discount relative to a co-creator of the product ensemble 107 who contributed a lower number of products towards the product ensemble 107.

The ensembles 107 described above are not limited to products and shopping. The ensembles 107 which may be posted to the pin board wall 110 may include other items other than products such as services. For example, in a rental car scenario, the ensemble 107 displayed on the pin board wall 110 may comprise a car reservation that has the name of the account owner dominantly displayed, such as having a large font, while the details of the car reservation are displayed less prominently, such as with text having a smaller font.

According to another exemplary embodiment, the ensembles 107 may include different combinations of excursions that may be taken on a particular travel package, such as various combinations of activities and excursions which may be taken on a ship cruise. For example, a ship cruise ensemble 107 may comprise snorkeling, biking, swimming, and shopping. The ensembles 107 in this scenario may be displayed on the pin board wall 110 in a waiting area of a travel agency. The ensembles 107 may be created by support staff at the travel agency.

As another exemplary embodiment, ensembles 107 may comprise on-sale items or products which are part of excess inventory that a merchant desires to dispose. These product ensembles 107 which a merchant desires to dispose may have substantial discounts and such discounts may be advertised with the ensembles 107 displayed on the pin board wall 110.

According to a further exemplary embodiment, ensembles 107 may comprise food recipes which are posted by patrons of a grocery store. The pin board wall 110 may be prominently positioned in the grocery store in order to motivate grocery store patrons to purchase the food products needed to prepare several different recipes which form the ensembles 107 being displayed.

As another example, the pin board wall 110 may be provided in a restaurant in which ensembles 107 may comprise different combinations of food and drink. The ensembles 107 may list several course meals with suggested wine selections. In addition to ensembles 107 comprising different combinations of food and drink, the same pin board wall 110 may be used for different types of games such as trivia games. Restaurant patrons may pass time in a waiting area by participating in games in which the ensembles 107 include elements of the game, such as questions in a trivia game.

The pin board wall 110 and ensembles 107 may be provided in any social context in which patrons are expected to wait, such as in professional offices, like doctors, lawyers, certified public accountants, etc. The pin board wall 110 and ensembles 107 are not limited to the specific scenarios/elements described above and may include other alternative applications as understood by one of ordinary skill the art.

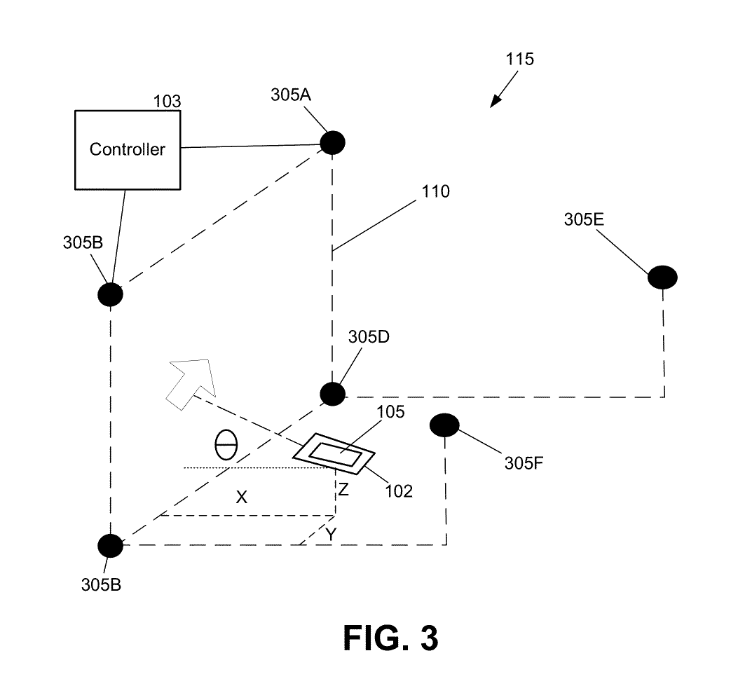

FIG. 3 is a diagram of system 115 for determining the direction of transfer of product ensembles 107 to and from a portable computing device 102 relative to a pin board wall 110. The system 115 may comprise the controller 103 coupled to a plurality of sensors 305 which are designed to track a position of the PCD 102 and its display 105 relative to the geometric planar surface defined by the pin board wall 110. The sensors 305 may comprise wireless fidelity (“WI-FI”) access points of a wireless LAN network 142 (SEE FIG. 1B). Alternatively, the sensors 305 may comprise BLUETOOTH™ low energy (“BTLE”) radio frequency transceivers according to an exemplary embodiment. The sensors 305 may also comprise acoustic type sensors and/or any combination of the aforementioned types of sensors 305.

The pin board wall 110 may generally have a rectangular shape as understood by one of ordinary skill in the art. However other shapes, such as elliptical, circular, square, triangular, pentagonal, hexagonal, octagonal, trapezoidal, and other like geometrical shapes are well within the scope of the inventive system 115. Usually those geometrical shapes with right angles are better suited for the inventive system 115 as will be described below.

In the exemplary embodiment illustrated in FIG. 3, the pin board wall 110 has generally a rectangular shape. Four sensors 305A-D may be positioned at the four corners of the pin board wall 110. Meanwhile, two additional sensors 305E-F may be positioned at a distance away from the geometric plane defined by the four sensors 305A-D.

Each of the sensors 305 may work together within subgroups by the controller 103 in order to use triangulation techniques, as understood by one of orders skill the art, in order to ascertain the XYZ coordinates of the PCD 102 relative to the pin board wall 110. The controller one three may also work with a gyroscope 457 and a compass module 417 which reside within the PCD 102 in order to gather additional position information such as an angle theta that the planar display 105 of the PCD 102 may have with the pin board wall 110.

Once the angle theta is approximately determined by the controller 103, the controller 103 may display a screen pointer 302 on the pin board wall 110 in order to provide feedback to the operator of the PCD 102 so that the operator may see the approximate “swiping” destination or reception area with respect to product ensembles 107 which may be uploaded and/or downloaded with the PCD 102 relative to the pin board wall 110. In the exemplary embodiment illustrated in FIG. 3, the screen pointer 302 is depicted as an arrow. However, other screen pointers 302 may be employed without departing from the scope of the disclosure. When multiple screen pointers 302 are displayed for multiple PCDs 102, the controller 103 may display these screen pointers 302 with unique visual cues such as, but not limited to, unique colors, patterns, shapes, etc. corresponding to each individual PCD 102.

As understood by one of ordinary skill the art, the controller 103 in combination with a client application module 401 running on the PCD 102 may perform any one of the following steps: the controller 103 may receive data from a pointer application within the client application model 401 that may include data from the gyroscope 457 and compass module 414 described below. The controller 103 may receive data from each one of the sensors 305 in order to triangulate the various XYZ coordinates of the PCD 102 relative to the pin board wall 110 as understood by one of ordinary skill the art.

The controller 103 may display the pointer 302 on the pin board wall 110 based on the data it collects from the sensors 305 and from sensors within PCD 102 (such as the data from the gyroscope 457 and compass module 414). Other sensors within the PCD 102 may include, but are not limited to, barometric sensors, altimeters, accelerometers, RGB light sensors, geomagnetic sensors, proximity sensors temperature sensors, humidity sensors, and gesture sensors. The controller 103 may receive further angle, compass directions, and altitude coordinates from the PCD 102. The controller 103 may update the position of the pointer to in response to any movement/adjustments of the PCD relative to pin board wall 110.

Referring to FIG. 4A, this figure is a functional block diagram of an exemplary, non-limiting aspect of a PCD 102 in the form of a wireless telephone for implementing methods and systems for creating and sharing product ensembles. As shown, the PCD 102 includes an on-chip system 402 that includes a multi-core central processing unit (“CPU”) 410A and an analog signal processor 426 that are coupled together. The CPU 410A may comprise a zeroth core 222, a first core 224, and an Nth core 230 as understood by one of ordinary skill in the art. Instead of a CPU 410A, a digital signal processor (“DSP”) may also be employed as understood by one of ordinary skill in the art.

A power management integrated circuit (“PMIC”) 407 may be responsible for distributing power to the various hardware components present on the chip 402. FIG. 4A also shows that the PCD 10 may include a compass module 414 and a gyroscope 457A. The data from the compass module 414 and gyroscope 457A may be used by the controller 103 to identify a position of the portable computing device (“PCD”) 102 relative to the pin board well 110.

In a particular aspect, one or more of the method steps described herein may be implemented by executable instructions and parameters, stored in the memory 412, that form the client application module(s) 401. These instructions that form the client application module(s) 401 may be executed by a CPU 410A, an analog signal processor 426, or any other processor to perform the methods described herein.

Further, all processors, 410, 426, the memory 412, the instructions stored therein, or a combination thereof residing within the PCD 102 and/or the controller 103 as described in this disclosure may serve as a means for performing one or more of the method steps described herein. As will be described below, the controller 103 may comprise hardware and software that manages a pin board wall/large display 110 which communicates with the CPU 410A residing within the PCD 102.

As illustrated in FIG. 4A, a display controller 428 and a touchscreen controller 430 are coupled to the CPU 410A. A touchscreen display 105 external to the on-chip system 402 is coupled to the display controller 428 and the touchscreen controller 430.

FIG. 4A is a schematic diagram illustrating an embodiment of a portable computing device (PCD) 102 that includes a video decoder 434. The video decoder 434 is coupled to the multicore central processing unit (“CPU”) 410A. A video amplifier 436 is coupled to the video decoder 434 and the touchscreen display 105. A video port 438 is coupled to the video amplifier 436. As depicted in FIG. 4A, a universal serial bus (“USB”) controller 440 is coupled to the CPU 410A. Also, a USB port 442A is coupled to the USB controller 440.

Memory 412 and a subscriber identity module (“SIM”) card 446 may also be coupled to the CPU 440A. Further, as shown in FIG. 4, a digital camera 448 may be coupled to the CPU 440A. In an exemplary aspect, the digital camera 448 is a charge-coupled device (“CCD”) camera or a complementary metal-oxide semiconductor (“CMOS”) camera.

As further illustrated in FIG. 4A, a stereo audio CODEC 450 may be coupled to the analog signal processor 426. Moreover, an audio amplifier 452 may be coupled to the stereo audio CODEC 450. In an exemplary aspect, a first stereo speaker 454 and a second stereo speaker 456 are coupled to the audio amplifier 452. FIG. 4A shows that a microphone amplifier 458 may be also coupled to the stereo audio CODEC 450. Additionally, a microphone 460 may be coupled to the microphone amplifier 458. In a particular aspect, a frequency modulation (“FM”) radio tuner 462 may be coupled to the stereo audio CODEC 450. Also, an FM antenna 464 is coupled to the FM radio tuner 462. Further, stereo headphones 466 may be coupled to the stereo audio CODEC 450.

FIG. 4A further illustrates a radio frequency (“RF”) transceiver 468 may be coupled to the analog signal processor 426. An RF switch 470 may be coupled to the RF transceiver 468 and an RF antenna 472. As shown in FIG. 4, a keypad 474 may be coupled to the analog signal processor 426. Also, a mono headset with a microphone 476 may be coupled to the analog signal processor 426. Further, a vibrator device 478 may be coupled to the analog signal processor 426.

FIG. 4A also shows that a power supply 480, for example a battery, is coupled to the on-chip system 402. In a particular aspect, the power supply includes a rechargeable DC battery or a DC power supply that is derived from an alternating current (“AC”) to DC transformer that is connected to an AC power source.

As depicted in FIG. 4A, the touchscreen display 105, the video port 438, the USB port 442A, the camera 448, the first stereo speaker 454, the second stereo speaker 456, the microphone 460, the FM antenna 464, the stereo headphones 466, the RF switch 470, the RF antenna 472, the keypad 474, the mono headset 476, the vibrator 478, thermal sensors 457B, and the power supply 480 are external to the on-chip system 402.

FIG. 4B is a diagram of exemplary software modules which may be part of a client application module 401 that is part of the system 101 for creating and sharing product ensembles 107. The client application module 401 which may reside on a PCD 102 (SEE FIG. 4A) may include, but is not limited to, the following software modules: a notification module 403; an item capture module 405; a design board module 409; a social/comment board module 411; a store navigation module 413; a wish list module 415; an ensemble collection module 417; a shopping basket module 419; a purchase history module 421; a push-to-device module 423; a store connect module 425; a persona manager 427; and a trash bin module 429.

The notification module 403 may be responsible for all in-store message communication from the PCD 102 to the controller 103 and other computers operated by the store owner. The messages posted to the notification module 403 may be automatically removed based on rules and/or events (e.g.—A notification may be sent to the PCD 102 upon entering the electronics department of a department store which pose an event such as a message stating that there is a 15% off sale on ABC brand headphones). When the operator the PCD 102 lease the store, notifications may be automatically removed from the PCD 102 in response to a command from the controller 103.

The item capture module 405 may include, but is not limited to, various types of methods for retrieving product information into the client application module 401 residing/running on the PCD 102. The item capture module 405 may include a scan barcode method, and image recognition method, a product recognition method, an ensemble recognition method, a retrieved from device method, a device push method, optical character recognition method, a BTLE™ brand RF coupling method, an near field communication (“NFC”) method, a radio frequency-identification (“RFID”) method, and a manual key entry method.

The scan barcode method may include the ability of the PCD 102 to read both one-dimensional and two dimensional machine-readable codes 111 such as barcodes as discussed above. These machine readable codes 111 may represent a shopkeeper unit (“SKU”) and/or retailer specific product identifiers.

The image recognition method may include the ability of the PCD 102 to recognize a unique two-dimensional image of a product or product ensemble 107 using off-the-shelf software vision-based image recognition, such as the VUFORIA™ software platform sold by QUALCOMM™ Inc., as of this writing.

The product recognition method may include the ability of the PCD 102 to directly “recognize” a scan of an actual product. Multiple image and data point sets may need to be recorded for each product for this method.

The ensemble recognition method of the item capture module 405 may include the ability of the PCD 102 to directly “recognize” a scan of an entire ensemble 107. Multiple angles may need to be recorded and accessed by the controller for each product ensemble 107. Each product ensemble 107 would be defined by a single unique identifier 202 and may be linked to multiple product identifiers.

The retrieve from device method of the item capture module 405 may include the ability of the PCD 102 to “pull” a product or product ensemble 107 from another connected PCD 102. This may include an interactive digital display/interactive graphical user interface that may coach the respective to users of the PCDs 102.

The device push method of the item capture module 405 may include the ability of the PCD 102 to receive a product “pushed” or swiped from another connected PCD 102. This could include a sales associate PCD 102 with a tablet PC, or a mobile phone of a sales associate, which could transfer a product ensemble 107 to a consumer operating his or her PCD 102. Permission for receiving pushed products from the operator of a PCD 102 would need to be enforced by the controller 103 in order to protect PCDs 102 from unwanted pushes.

The optical character recognition (“OCR”) method of the item capture module 405 may include the ability of the PCD 102 to identify a product by scanning the product identifier located on a price tag 109 (SEE FIG. 1A).

The a BTLE™ brand RF coupling method of the item capture module 405 may include BLUETOOTH™ 4.0 RF couplings for exchanging information between products 10,20 and a PCD 102. BLUETOOTH™ 4.0 RF couplings will be available in most PCDs 102, such as smartphones within several months of this writing.

The near field communication (“NFC”) method of the item capture module 405 may comprise NFC poster mode types of communications as understood by one of ordinary skill the art. Products 10, 20 may be equipped with NFC tags while the PCDs one or two may comprise NFC readers for such tags.

The radio frequency-identification (“RFID”) method of the item capture module 405 may include RFID readers on each PCD 102 for reading RFID tags positions on products 10, 20.

The manual key method of the item capture module 405 may include a module that prompts the operator of the PCD 102 to enter any alphanumeric characters corresponding to the human readable code present on product tags 109. An operator of the PCD 102 may manually enter product identifiers into this manual key module of the item capture module 405.

The design board module 409 has been described above in connection with FIG. 1A. The design board module 409 may display visual representations of products which form product ensemble 107. An operator of a PCD 102 may add or delete products from product ensemble 107 by using the design board module 409 as described above in connection with FIGS. 1A-2.

The social board/comment board module 411 allows an operator the PCD 102 to leave comments about products found in a store by the operator. Comments may be provided on any product in the store, as well as any product ensemble 107 posted to the pin board wall 110. Further details of the social board/comment board module 411 will be described below in connection with FIG. 4C.

The store navigation module 413 may be activated or used by an operator the PCD 102 in order to find a specific product within a store. The store navigation module 413 may use one or more sensors of the PCD 102 in order to assist with finding products within a store. Such sensors include, but are not limited to, a GPS module, cell tower transport triangulation, WiFi node triangulation, WiFi signal strength triangulation, BLTE™ brand RF coupling/mesh triangulation, data from the compass module 414, and data from the gyroscope 457. From the sensors, the location of the PCD 102 within a particular store may be accurately determined. With the knowledge of the store's planogram, the store navigation module for 10 may provide the most efficient route to a product of interest that is present within the store. The store navigation module 413 may be activated/executed from any product search which indicates that a product is in stock and present at the current store.

The WishList module 415 may store collections of products intentionally saved by an operator the PCD 102. The number of WishLists that operator may create may be numerous and may be tailored to specific events/people. Wishlists may be pushed from one PCD 102 two another PCD 102 as long as both PCDs 102 reside within the same WiFi network 142 as understood by one of ordinary skill the art. Wishlists may be linked to persona filters as will be described below.

The ensemble collection module 417 of the client application model 401 may store product ensemble 107 which have been created and/or downloaded by the operator the PCD 102. Product ensembles 107 present on one PCD 102 may be pushed to another PCD 102 that is within the same WiFi network 142. The ensemble collection module 417 may also be linked to persona filters as will be described in further detail below.

The shopping basket module 419 may comprise a digital repository of items that an operator the PCD 102 is intending to purchase during usage of the client application module 401. A purchase may occur in store as a push to device at checkout like a POS terminal 119, or it may occur as an out of store purchase such as an e-commerce purchase online.

The purchase history module 421 of the client application module 401 may provide a detailed purchase history as well as a link to the retailers return management system (“RMS”) which would allow for up-to-date records of purchases as well as returns to the store. Meanwhile, the push-to-device module 423 may provide the PCD 102 the ability to push a product, a product ensemble 107, a comment, a shopping basket to another connected PCD 102 residing within the same WiFi network 142.

The store connect module 425 may be responsible for communications as well as retrieving data for all products being scanned/identified with the PCD 102. The store connect module 425 may couple the PCD 102 to the private WiFi network 142 which may be optimized provide fast, reliable content delivery to the PCD 102 while the PCD 102 is in the store. The store connect module 425 may provide the credentials for accessing the communications network 142 within the store.

The persona manager module 427 may provide a user interface such that the operator of the PCD 102 may manage a plurality of personas associated with the account by the operator. Personas, as will be described below, include profiles of people related to a primary account holder. Further details about personas will be described below in connection with FIG. 4D which illustrates an exemplary user interface for the persona manager module 427.

The trashbin module 429 may track deletions made by the operator of the PCD 102. Working with the controller 103, the trashbin module 429 may provide a mechanism so that any action taken by an operator a PCD 102 is not completely destructive such that any data which is created and later deleted may be undeleted and restored as desired by the operator the PCD 102.

FIG. 4C is an exemplary screen display 105 of a graphical user interface for a portable computing device 102 which allows an operator to provide comments about a product 10. The graphical user interface of FIG. 4C is generated by the social board/comment board module 411 of the client application module 401 described above in connection with FIG. 4B.

The graphical user interface may display a visual representation of a product 10A. In the exemplary embodiment illustrated in FIG. 4C, the visual representation of product 10A comprises a shirt. As noted above, other products 10, 20 besides clothing are included within the scope of this disclosure as understood by one of ordinary skill in the art. In addition to the visual display of the product 10A, the graphical user interface of the common board module 411 may further comprise a region 450 for receiving an alphanumeric text comments produced by the operator of the PCD 102. The comments may be stored by the controller 103 in a database which is associated with each product 10, 20.

The comments for each product 10, 20 stored in the database may be displayed to an operator of a PCD 102 when the social board/common board module 411 is executed/run. The operator of the PCD 102 may search for products which have been provided comments by other consumers by using a search field 455 in which product names may be entered by the operator.

FIG. 4D is a diagram of an exemplary screen display 105 for adjusting settings of a persona manager module 427 that may be part of the client application module 401 residing/running on the PCD 102. The persona manager module 427 may work with the product ensemble collection module 417 to build different ensembles 107/combinations of products 10, 20 based on the intended recipient of the product 10, 20 being reviewed by the operator of the PCD 102.

The persona manager module 427 may track different profiles/people who can be associated with the primary account holder or operator of the PCD 102. In other words, the persona manager module 427 may track desired products of people who are associated with a single operator of a primary account holder who is an operator of the PCD 102. For example, the persona manager module 427 may track desired products for a spouse of the operator of the PCD 102 as well as children of the operator of the PCD 102.

The persona manager module 427 may have demographic information about the account being used by/associated with the operator of the PCD 102. For example, a first account may be associated with a first persona which is a male person who is between 40 and 50 years of age.

So when the operator of the PCD 102 is logged into the first account, the persona manager module 427 may have knowledge that the operator is between 40 and 50 years of age and is a male. When the operator expresses interest in a product by scanning it with their PCD 102, the persona manager module 427 may determine if the product 10, 20 should be associated with a first persona or other different personas that may be associated with the account.

Other different personas that may be associated with a single account may include other operators associated with the current operator of the PCD 102. As noted previously, as an example, another persona could be a spouse persona which is associated with the spouse of the first account holder. Another persona could comprise a child persona which is associated with a child of the first account holder.

The persona manager module 427 may have various types of rules to determine what persona should be associated with a particular product 10, 20 being scanned based on the demographic data that the persona manager module 427 may have with respect to be different personas associated with the first account (i.e., the primary persona associated with the account, a spouse persona associated with a spouse of the account holder, a child persona associated with a child of the account holder).

When the operator of the PCD 102 scans any product 10, 20 and sends that product data to the ensemble collection module 417, the persona manager module 427 may use demographic data associated with the personas as well as the current location of the PCD 102 in order to intelligently determine which is the appropriate persona with which the scan product data should be associated.

For example, if the PCD 102 is positioned within the men's department of a department store and the account holder scans in a product 20 such as jeans in the men's department, then the personal manager module 427 may intuitively determine that the jeans should be associated with the account holder's primary persona who is a male that is between 40 and 50 years of age.

As another example, if the PCD 102 is geographically positioned within the women's department of a department store and the account holder scans in a product 10, such as a dress in the women's department, then the persona manager module 427 may intuitively determine that the dress should be associated with the spouse persona for the account of the operator of the PCD 102.

In yet another example, if the PCD 102 is geographically positioned within the toy section of a department store, and the account holder scans in a product 10, 20 such as a child's toy with the PCD 102, then the persona manager module 427 may intuitively determine that the toy should be associated with the child persona for the account of the operator of the PCD 10.

Once the persona manager module 424 determines the appropriate persona for the product 10, 20 which is scanned, then it may create an ensemble 107 of products which are related to the scanned product 10, 20 and which relate to the determined persona associated with the scanned product 10, 20. So for the toy example, the persona manager module 424 may create a product ensemble 107 of toys which are age appropriate for the child persona associated with the account holder.

As illustrated in FIG. 4D, the persona manager 424 may comprise a plurality of personas 460, such as, but not limited to, a persona 460A associated with the primary account; a persona 460B associated with a spouse of the primary account holder; and children personas 460C, 460D associated with the primary account holder. The operator the PCD one two may also specify other additional personas such as friends, neighbors, acquaintances, etc.

The persona manager 424 may allow the operator the PCD 102 to customize each persona. As illustrated in FIG. 4D, the second child persona 460D is being customized with various information 475 about the persona 460D of interest.

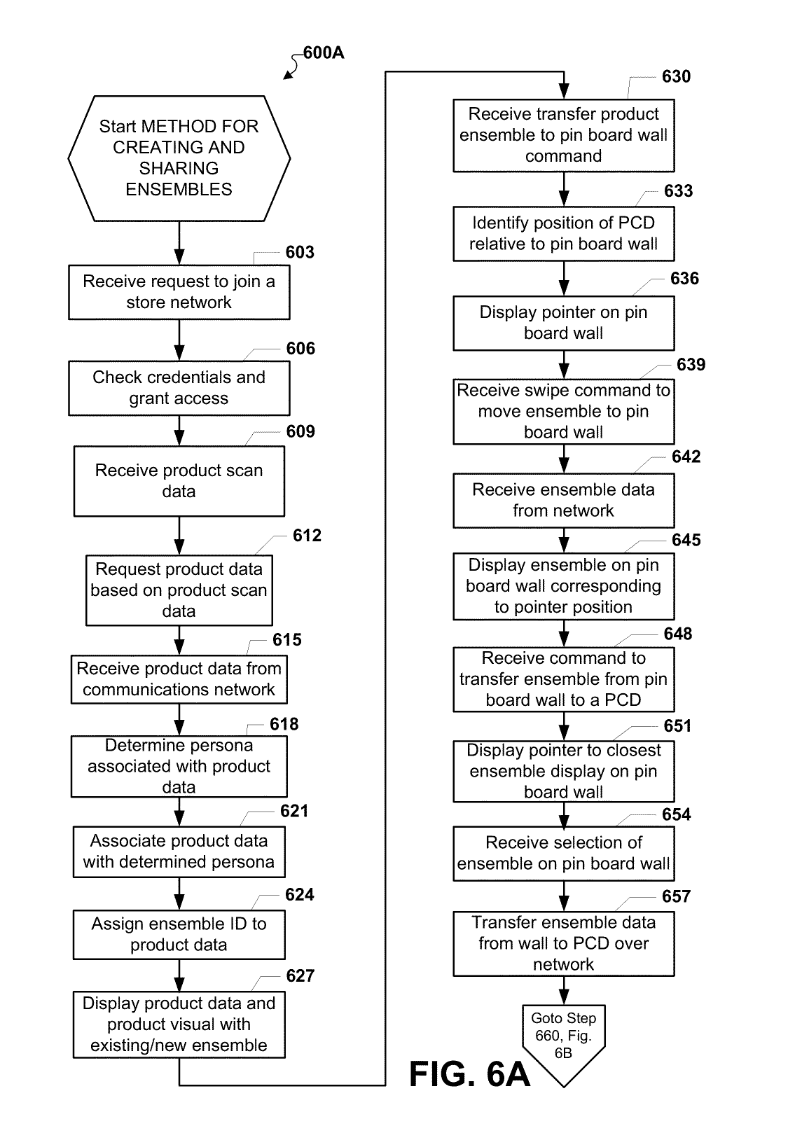

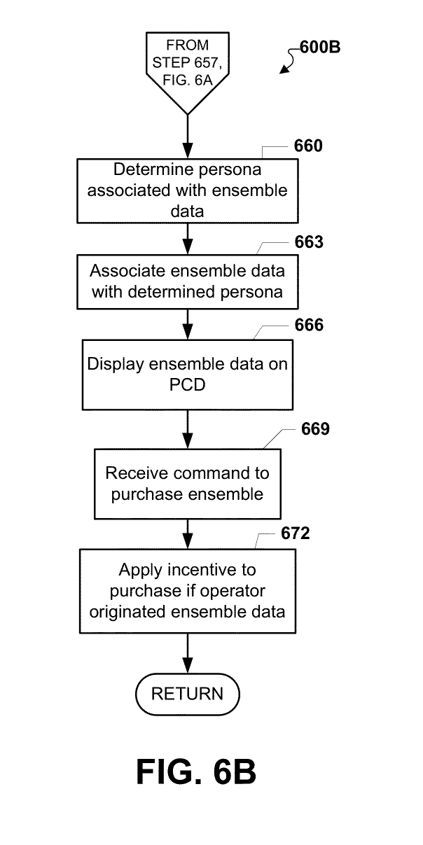

FIG. 5 is a diagram of a general purpose computer which may be part of the controller 103 for the pin board wall 110. Specifically, FIG. 5 is a functional block diagram of an exemplary, nonlimiting aspect of a general-purpose computer for implementing a computer-implemented method 600 (SEE FIG. 6) for creating and sharing product ensembles 107.

The exemplary operating environment for the system 101 of FIG. 1A includes a general-purpose computing device in the form of a conventional computer that may form the controller 103A for the pin board wall 110. Generally, a computer 103A includes a processing unit 521, a system memory 522, and a system bus 523 that couples various system components including the system memory 522 to the processing unit 521.

The system bus 523 may be any of several types of bus structures including a memory bus or memory controller, a peripheral bus, and a local bus using any of a variety of bus architectures. The system memory 522 includes a read-only memory (ROM) 524 and a random access memory (RAM) 525. A basic input/output system (BIOS) 526, containing the basic routines that help to transfer information between elements within computer 103A, such as during start-up, is stored in ROM 524.

The computer 103A can include a hard disk drive 527A for reading from and writing to a hard disk, not shown, a memory drive 528 for reading from or writing to a removable memory device 529, and an optical disk drive 530 for reading from or writing to a removable optical disk 531 such as a CD-ROM or other optical media. Hard disk drive 527A, memory device drive 528, and optical disk drive 530 are connected to system bus 523 by a hard disk drive interface 532, a removable memory interface 533, and an optical disk drive interface 534, respectively.

Although the exemplary environment described herein employs hard disk 527A, removable memory 529, such as a USB drive and/or flash memory, and removable optical disk 531, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment without departing from the scope of the invention. Such uses of other forms of computer readable media besides the hardware illustrated will be used in internet connected devices such as in cellular phones 102 and/or personal digital assistants (PDAs) 102, described above.

The drives and their associated computer readable media illustrated in FIG. 5 provide nonvolatile storage of computer-executable instructions, data structures, program modules, and other data for computer 103A. A number of program modules may be stored on hard disk 527, removable memory 529, optical disk 531, ROM 524, or RAM 525, including, but not limited to, an operating system 535, pin board controller software module(s) 103A, and a store product database module 111.

Program modules include routines, sub-routines, programs, objects, components, data structures, etc., which perform particular tasks or implement particular abstract data types. Aspects of the present invention may be implemented in the form of a downloadable, modules which are executed by the portable computing device 102 (SEE FIG. 1A) or the computer 103A of FIG. 5 in order to create and share product ensembles 107.

A user may enter commands and information into computer 103A through input devices, such as a keyboard 540 and a pointing device 542. Pointing devices may include a mouse, a trackball, and an electronic pen that can be used in conjunction with an electronic tablet. Other input devices (not shown) may include a microphone, joystick, game pad, satellite dish, scanner, or the like.

These and other input devices are often connected to processing unit 521 through a serial port interface 546 that is coupled to the system bus 523, but may be connected by other interfaces, such as a parallel port, game port, a universal serial bus (“USB”), or the like. The pin board wall 110 may also be connected to system bus 523 via an interface, such as a video adapter 548. As noted above, the pin board wall or display 110 may comprise any type of display device such as a liquid crystal display (“LCD”), a plasma display, an organic light-emitting diode (“OLED”) display, and a cathode ray tube (“CRT”) display.

The camera 535 may also be connected to system bus 523 via an interface, such as an adapter 570. As noted previously, the camera 535 may comprise a video camera such as a webcam. The camera 535 may include a CCD (charge-coupled device) camera or a CMOS (complementary metal-oxide-semiconductor) camera. In addition to the pin board wall 110 and camera 535, the computer 103A may include other peripheral output devices (not shown), such as speakers and printers.

The computer 103A may operate in a networked environment using logical connections to one or more remote computers 103B. The remote computer 103B may be another personal computer, a server, a mobile phone 102, a router, a network PC, a peer device, or other common network node. While the remote computer 103B typically includes many or all of the elements described above relative to the computer 103A, only a memory storage device 527B has been illustrated in FIG. 5.

The logical connections depicted in FIG. 5 include a local area network (“LAN”) 142A and a wide area network (“WAN”) 142B. Such networking environments are commonplace in offices, enterprise-wide computer networks, intranets, and the Internet.

When used in a LAN networking environment, the computer 103 is often connected to the local area network 142 through a network interface or adapter 553. When used in a WAN networking environment, the computer 103 typically includes a modem 554 or other means for establishing communications over WAN 142B, such as the Internet. Modem 554, which may be internal or external, is connected to system bus 523 via serial port interface 546.

In a networked environment, program modules depicted relative to the remote computer 133, or portions thereof, may be stored in the remote memory storage device 527B. These program modules residing on memory storage device 527B may include an additional database 111b and other program modules. It will be appreciated that the network connections shown are exemplary and other means of establishing a communications link 103 (SEE FIG. 1B) between the computers 103 and PCDs 102 may be used.

FIG. 6 is a flowchart illustrating a method 600 for creating and sharing product ensembles 107. Block 603 is the first step of method 600. In block 603, a request is received by the controller 103 for a PCD 102 to join the network 142 of the store. This request may be managed by the notification module 403 of FIG. 4B.

Next, in block 606, the controller 103 may check the credentials of the PCD 102 and grant access to the communications network 142 if the credentials are valid. Subsequently, in block 609, the PCD 102 may receive product scan data from a product tag 109. The item capture module 405 of FIG. 4B may manage this product scan data from the tag 109 or from another method, such as a digital photograph or an electronic product search in a database 111.

In block 612, the PCD 102 via the design board module 409 of FIG. 4B may request additional product data associated with the product scan. In block 615, the PCD 102 may receive the additional product data from the communications network 142 which originates from the database 111 as illustrated in FIG. 1B.

In block 618, the persona manager module 427 may determine the persona associated with the product data. For example, the persona manager module 427 may determine if the product data is associated with the primary account holder or a spouse of the primary account holder. In block 621, after the persona manager module 427 has determined the persona to associate with the product scan data, the persona manager module 427 creates this association in memory. In block 624, the design board or persona filter four and 27 may assign the product data to an ensemble identifier 202.

Next, in block 627, a product visual and the product data may be displayed with within existing ensemble one of seven or a new ensemble 107 created by the ensemble collection module 417 and/or the design board 409.

In block 630, the design board module 409 running on the PCD 102 may receive a command to transfer the product ensemble 107 to the pin board wall 110. In block 633, the controller 103 for the pin board 110 may identify relative positions of the PCD 102 relative to the pin board wall 110.

In block 636, the pin board wall 110 may display a pointer 302 which corresponds to a swipe angle theta for the PCD 102 as illustrated in FIG. 3. In block 639, the controller 103 may receive a “swipe” command to move the product ensemble 107 from the PCD 102 to the pin board wall 110.

In block 642, the controller 103 may receive the product ensemble data from the PCD 102 over the communications network 142. In block 645, the controller may display the product ensemble 107 of the pin board wall 110 corresponding to a position of the pointer 302.

Subsequently, in block 648, the controller 103 may receive command to transfer a product ensemble 107 from the pin board wall 110 to a PCD 102. This command may be initiated by the operator of the PCD 102 who either “swipes” from the pin board wall 110 or “taps” twice on the product ensemble present on the pin board wall 110.

In block 651, the controller 103 displays the pointer through to adjacent to the closest product ensemble 107. In block 654, the controller 103 receives a selection of the product ensemble 107 being displayed on the pin board wall 110. Subsequently, in block 657, the controller 103 may transfer the product ensemble data over the communications network 142 to the PCD 102. Next, in block 660, the persona filter module 427 may determine the persona associated with the product ensemble data received from the communications network 142 originating from the controller 103.

In block 663, the persona module 427 may associate the product ensemble data with a persona stored in memory based on one or more rules. Next, in block 666, the design board module 409 may display the product ensemble 107 downloaded from the pin board wall 110 onto the display 105 of the PCD 102.

In block 669, the controller 103 may receive command of the PCD 102 to purchase the product ensemble 107. In block 672, the controller 103 may apply a an incentive towards the purchase of the ensemble 107 if the operator of the PCD 102 originated one or more elements of the ensemble 107 as described above. Such an incentive may include, but is not limited to, a discount, a gift card, store credit, loyalty points, etc. The method 600 then returns.

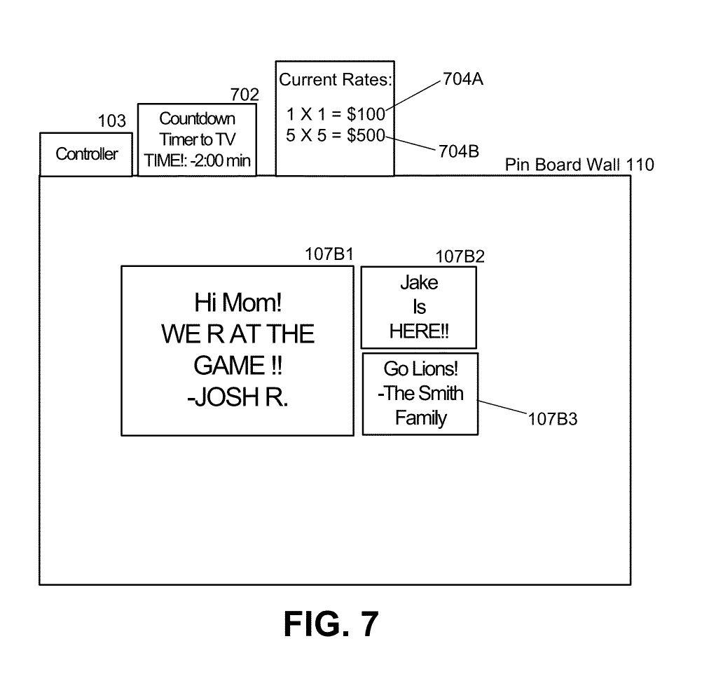

FIG. 7 is an exemplary screen display for a pin board wall 110 that supports communications in connection with a televised live event. According to this exemplary embodiment, the controller 103 (not illustrated) may also be coupled to a countdown-timer 702 which tracks the time remaining until the pin board wall 110 will be displayed on TV such as for a live event like a sporting event or music concert. The controller 103 may monitor requests from a plurality of PCDs 102 who wish to post ensembles 107 that comprise a plurality of words that may be keyed in by an operator of a PCD 102. For example, many fans of live events, such as professional sports fans as well as fans for music concerts, often desire to let their friends and family know that they are present at the live event.

The exemplary pin board wall 110 illustrated in FIG. 7 allows an operator of a PCD 102 to purchase ensembles 107 of various physical sizes for posting words. The controller 103 may screen the messages desired to be posted in the word ensembles 107. The controller 103 may screen the messages for profanity, racial slurs, and the like such that such messages cannot be posted by an operator of a PCD 102.

The controller 103 may have two or more pricing displays 704 which indicate the current price for different sized ensembles 107. For example, a first pricing display 704A may track the current price of an ensemble 107 of a first size. A second pricing display 704B may track the current price of an ensemble 107 of a second size, in which the second size is larger or greater than the first size.

In the exemplary embodiment illustrated, the first pricing display 704A tracks the price of a 1′×1′ rectangular display while the second pricing display 704B tracks the price of a 5′×5′ display. The controller 103 may increase the prices of each pricing display 704 based on the volume of requests that it may receive from a plurality of PCDs 102. As the volume of requests increase, the controller 103 may also incrementally increase the prices listed on each pricing display 704 for at least the two different sized ensembles 107.

In the exemplary embodiment illustrated in FIG. 7, one operator of a PCD will 102 purchased a 5′×5′ ensemble 107B1 in which the operator authored the following statement: “Hi Mom! We R AT THE GAME!—JOSH R . . . ” Similarly, to other operators of PCDs 102 purchased 1′×1′ ensembles in which the two operators of PCDs 102 wanted to express the following two statements: “Jake is here!”—107B2 and, “Go Lions—The Smith Family . . . .”

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the disclosure. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for creating and sharing product ensembles between a portable computing device (“PCD”) and a pin board wall, the method comprising:
receiving product scan data for a product;
displaying a visual representation of the product on a display as part of a product ensemble;
receiving a command to transfer the product ensemble from a PCD to the pin board wall;
transferring data for the product ensemble over a communications network from the PCD to the pin board wall; and
displaying the transferred product ensemble on the pin board wall.

2. The method of claim 1, further comprising receiving a command to transfer the product ensemble from the pin board wall to another PCD.

3. The method of claim 1, further comprising displaying a pointer on the pin board wall in a location generally corresponding to an angle of the PCD relative to the pin board wall.

4. The method of claim 1, further comprising receiving a command from a PCD to change one or more elements of the transferred product ensemble.

5. The method of claim 3, further comprising displaying a plurality of pointers on the pin board wall.

6. The method of claim 5, wherein each pointer comprises a unique visual feature.

7. The method of claim 1, wherein the command to transfer of the product ensemble from a PCD to the pin board wall comprises a hand gesture.

8. The method of claim 7, wherein the hand gesture comprises a swipe motion.

9. The method of claim 1, further comprising: receiving a command to purchase the product ensemble.

10. The method of claim 9, further comprising applying a discount to the purchase if the PCD requesting the purchase originated the product ensemble.

11. A computer system for creating and sharing product ensembles between a portable computing device (“PCD”) and a pin board wall, the system comprising:
a processor operable for:
receiving product scan data for a product;
displaying a visual representation of the product on a display as part of a product ensemble;
receiving a command to transfer the product ensemble from a PCD to the pin board wall;
transferring data for the product ensemble over a communications network from the PCD to the pin board wall; and
displaying the transferred product ensemble on the pin board wall.

12. The system of claim 11, wherein the processor is further operable for receiving a command to transfer the product ensemble from the pin board wall to another PCD.

13. The system of claim 11, wherein the processor is further operable for displaying a pointer on the pin board wall in a location generally corresponding to an angle of the PCD relative to the pin board wall.

14. The system of claim 11, wherein the processor is further operable for receiving a command from a PCD to change one or more elements of the transferred product ensemble.

15. The system of claim 13, wherein the processor is further operable for displaying a plurality of pointers on the pin board wall.

16. The system of claim 15, wherein each pointer comprises a unique visual feature.

17. The system of claim 11, wherein the command to transfer of the product ensemble from a PCD to the pin board wall comprises a hand gesture.

18. The system of claim 17, wherein the hand gesture comprises a swipe motion.

19. The system of claim 11, wherein the processor is further operable for receiving a command to purchase the product ensemble.

20. The system of claim 19, wherein the processor is further operable for applying a discount to the purchase if the PCD requesting the purchase originated the product ensemble.

21. A computer system creating and sharing product ensembles between a portable computing device (“PCD”) and a pin board wall, the system comprising:
means for receiving product scan data for a product;
means for displaying a visual representation of the product on a display as part of a product ensemble;
means for receiving a command to transfer the product ensemble from a PCD to the pin board wall;
means for transferring data for the product ensemble over a communications network from the PCD to the pin board wall; and
means for displaying the transferred product ensemble on the pin board wall.

22. The system of claim 21, further comprising means for receiving a command to transfer the product ensemble from the pin board wall to another PCD.

23. The system of claim 21, further comprising means for displaying a pointer on the pin board wall in a location generally corresponding to an angle of the PCD relative to the pin board wall.

24. The system of claim 21, further comprising means for receiving a command from a PCD to change one or more elements of the transferred product ensemble.

25. The system of claim 23, further comprising means for displaying a plurality of pointers on the pin board wall.

26. The system of claim 25, wherein each pointer comprises a unique visual feature.

27. The system of claim 21, wherein the command to transfer of the product ensemble from a PCD to the pin board wall comprises a hand gesture.

28. The system of claim 27, wherein the hand gesture comprises a swipe motion.

29. The system of claim 21, further comprising means for receiving a command to purchase the product ensemble.

30. The system of claim 29, further comprising means for applying a discount to the purchase if the PCD requesting the purchase originated the product ensemble.

31. A computer program product comprising a non-transitory computer usable medium having a computer readable program code embodied therein, said computer readable program code adapted to be executed to implement a method for creating and sharing product ensembles between a portable computing device (“PCD”) and a pin board wall, said method comprising:
receiving product scan data for a product;
displaying a visual representation of the product on a display as part of a product ensemble;
receiving a command to transfer the product ensemble from a PCD to the pin board wall;
transferring data for the product ensemble over a communications network from the PCD to the pin board wall; and
displaying the transferred product ensemble on the pin board wall.

32. The computer program product of claim 31, wherein the program code implementing the method further comprises:
receiving a command to transfer the product ensemble from the pin board wall to another PCD.

33. The computer program product of claim 31, wherein the program code implementing the method further comprises:
displaying a pointer on the pin board wall in a location generally corresponding to an angle of the PCD relative to the pin board wall.

34. The computer program product of claim 31, wherein the program code implementing the method further comprises:
receiving a command from a PCD to change one or more elements of the transferred product ensemble.

35. The computer program product of claim 33, wherein the program code implementing the method further comprises:
displaying a plurality of pointers on the pin board wall.

36. The computer program product of claim 35, wherein each pointer comprises a unique visual feature.

37. The computer program product of claim 31, wherein the command to transfer of the product ensemble from a PCD to the pin board wall comprises a hand gesture.

38. The computer program product of claim 37, wherein the hand gesture comprises a swipe motion.

39. The computer program product of claim 31, wherein the program code implementing the method further comprises:
receiving a command to purchase the product ensemble.

40. The computer program product of claim 39, wherein the program code implementing the method further comprises:
applying a discount to the purchase if the PCD requesting the purchase originated the product ensemble.
